(19) United States
(12) Patent Application Publication
(10) Pub. No.: US 2008/0217031 A1
(43) Pub. Date: Sep. 11, 2008

(54) Cargo fire net

(76) Inventor: Curtis Nathaniel Adams, Memphis, TN (US)

Correspondence Address: CURTIS N. ADAMS, SUITE 1, 3529 BLACKBERRY BUSH ROAD, MEMPHIS, TN, 38115, US

(21) Appl. No.: 11/713,656

(22) Filed: Mar. 5, 2007

(51) Int. Cl. A62C 3/07

(52) U.S. Cl. 169/62

(57) ABSTRACT

The “CARGO FIRE NET” looks much like a conventional net, the difference is that it was invented to extinguish fires in cargo settings. What makes this net different is the fact that it has several “suppression lines” inside, and throughout it, with (8) evenly spaced, exposed brass “#6540 suppression jet heads” connected to those lines, so as to spray “non-corrosive fire suppression agent” in the occurrence of fire. The “non-corrosive fire suppression agent” will be delivered by way of a centrifugal pump pulling from a 30 gal. holding tank, and into the net, so as to be sprayed. It can be used conventionally as a net, by draping it over the cargo, or non-conventional by suspending in a fixed state above the cargo. It's a net that extinguishes fires, just put it on the cargo, or hang it above the cargo, and connect it to “feed suppression line”, and walk away. When the “sensors” in the net detect an unacceptable temperature level, they will activate the system, thus starting the extinguishing process. All of this occurs with no attendant being involved, and ending the fear of “blind fires” during transport of cargo. Yes, the “CARGO FIRE NET” is the answer, a protector of Life, Property, and Merchandise. It's ready for industry, and industry is ready for it, “It's a better way”.

“CARGO FIRE NET” is the title of my invention; My name is Curtis N. Adams, I am the person who invented it on Saturday Morning at 6 a.m., on Oct. 23, 2004, my address is: 3529 BLACKBERRY BUSH ROAD, SUITE 1, MEMPHIS, TN 38115. It has the appearance of a conventional cargo net, however the “CARGO FIRE NET” is design to extinguish fires; it is made of flame retardant material. A couple of it's applications are as follows; A.) Draped over cargo, not unlike any net is used, or B.) In a fixed state, suspended above cargo by it's “long positioning straps”, so as to be adjusted to a desired height above cargo.

### BACKGROUND of THE INVENTION

The “CARGO FIRE NET” would be under the category, I feel, of fire suppression. I discovered the need for my invention while doing a supervised burn, and demonstration for a company, whose professional area of interest is cargo, and the protection of it while being shipped especially from fire. The supervised burn was done for fact-finding, and results, now as it has turn out, for discoveries as well. After the burn/demonstration was finished, representatives of the company, and I both agreed that it was unsuccessful. That's when those same representatives approached me before leaving the burn site, and ask if I could come up with some way to deploy from above, and if I were able to complete that task, the relationship between the company, and myself would be on a fast track to a successful business venture.

At that moment, I realized that there was a need, and a opening for the introduction of something entirely different, and new for the cargo industry. The other realization was that the only way they had been combating fires during shipment was with a conventional fire extinguisher, a great invention, but primitive when dealing with fires in the cargo world, especially during shipment. I say especially during shipping because, when a fire starts in the cargo bays, being the transporter of the cargo becomes a major headache, simply because you don't know the origin of the fire, nor how long it's been burning. Involving those two factors could, and more time than not, companies such as this end up losing their entire payload, and sometimes their means of transport, but not anymore thanks to the “CARGO FIRE NET”, “It's a better way”.

### BRIEF SUMMARY of THE INVENTION

The “CARGO FIRE NET” is used to put fires out in cargo holding situations, without causing extensive water, and or fire damage to the entire cargo holding area, and at times the means being used for transport is destroyed. Up until now, the way these fires have been combated has been primitive to say the least, and I say this because during shipping these fires can occur in blind areas in the cargo holding area, and because of limited space in that area, you may not be able to reach it to extinguish it. Being the transporter of the cargo becomes a major headache simply because you're not trained to combat fires therefore, you are now putting your life at risk, but not anymore thanks to the “CARGO FIRE NET”, it's a better way.

What makes it a better way you ask; well it solves the aforementioned problems.
1.) The origin of the fire isn't a reason for concern any more for the transporter of the cargo, because the “CARGO NET” is now in control, it will sense the fire, and extinguish it, I will go into detail as we go on, by means of drawings, and detailed descriptions.
2.) It does better than using a fire extinguisher, because you don't have to physically take on the fire yourself.
3.) Because of the sensors a fire is detected a lot sooner, thus extinguished sooner. SENSOR WILL BE OF THE NORMALLY OPEN THERMAL SWITCH VARIETY.
4.) The introduction of the “CARGO FIRE NET” would not only save the cargo, but property, and life as well.
5.) I don't know much about how insurance companies go about adjusting their rates, but your premiums would certainly have to go down with a sustained decrease of incidents. “It's a better way”

### BRIEF DESCRIPTION OF SEVERAL VIEWS OF THE DRAWINGS

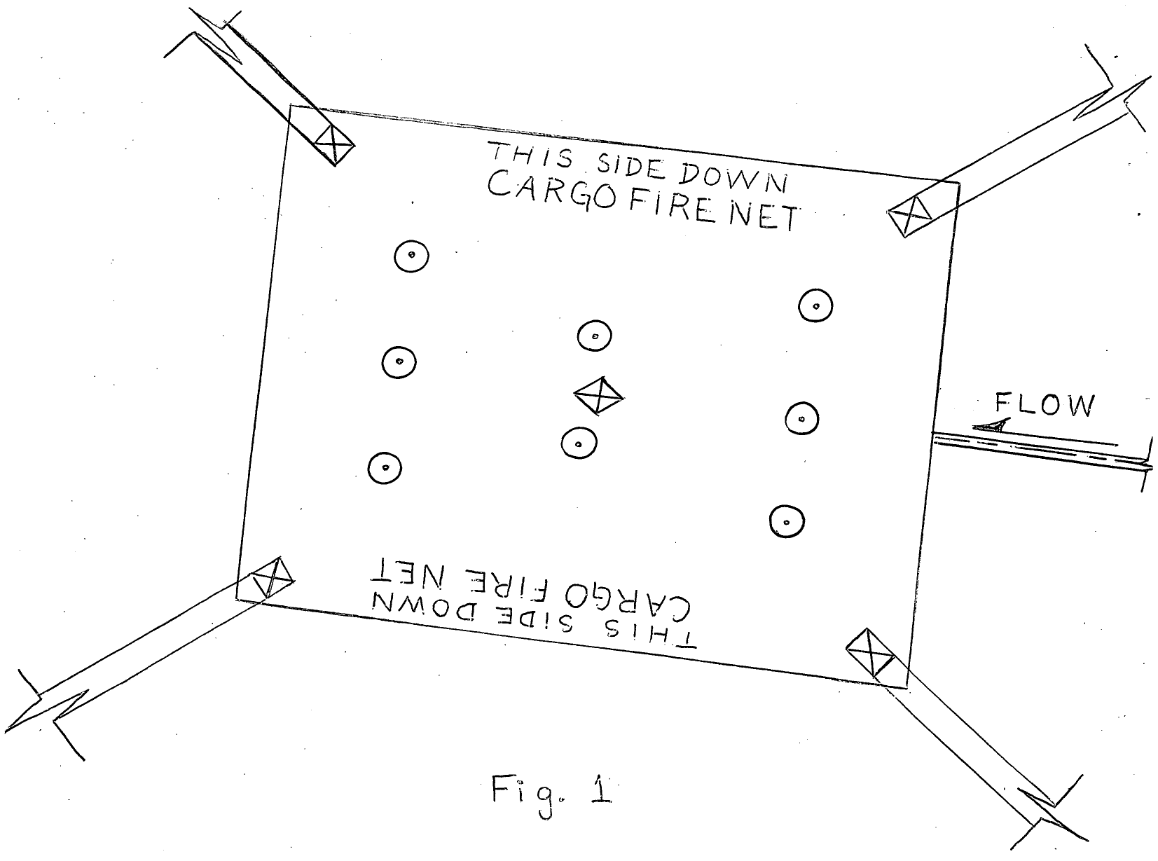

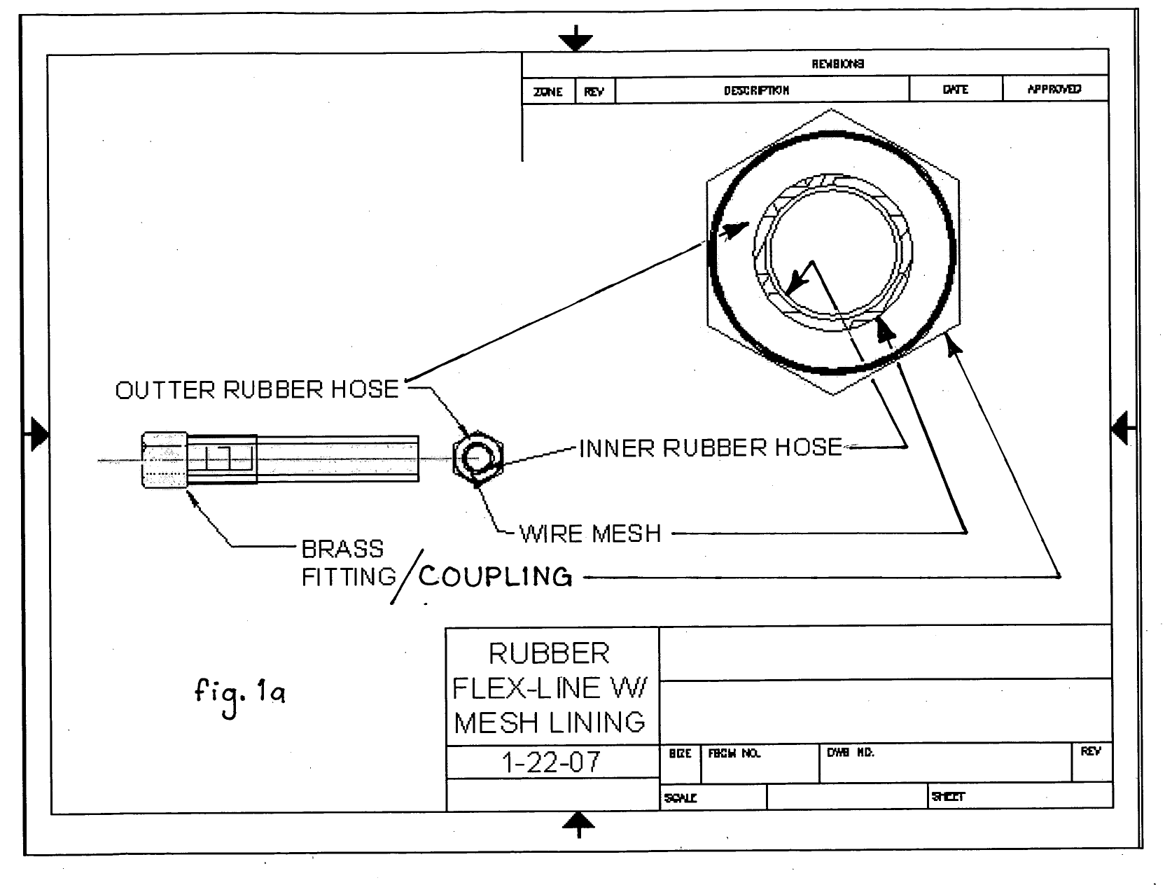

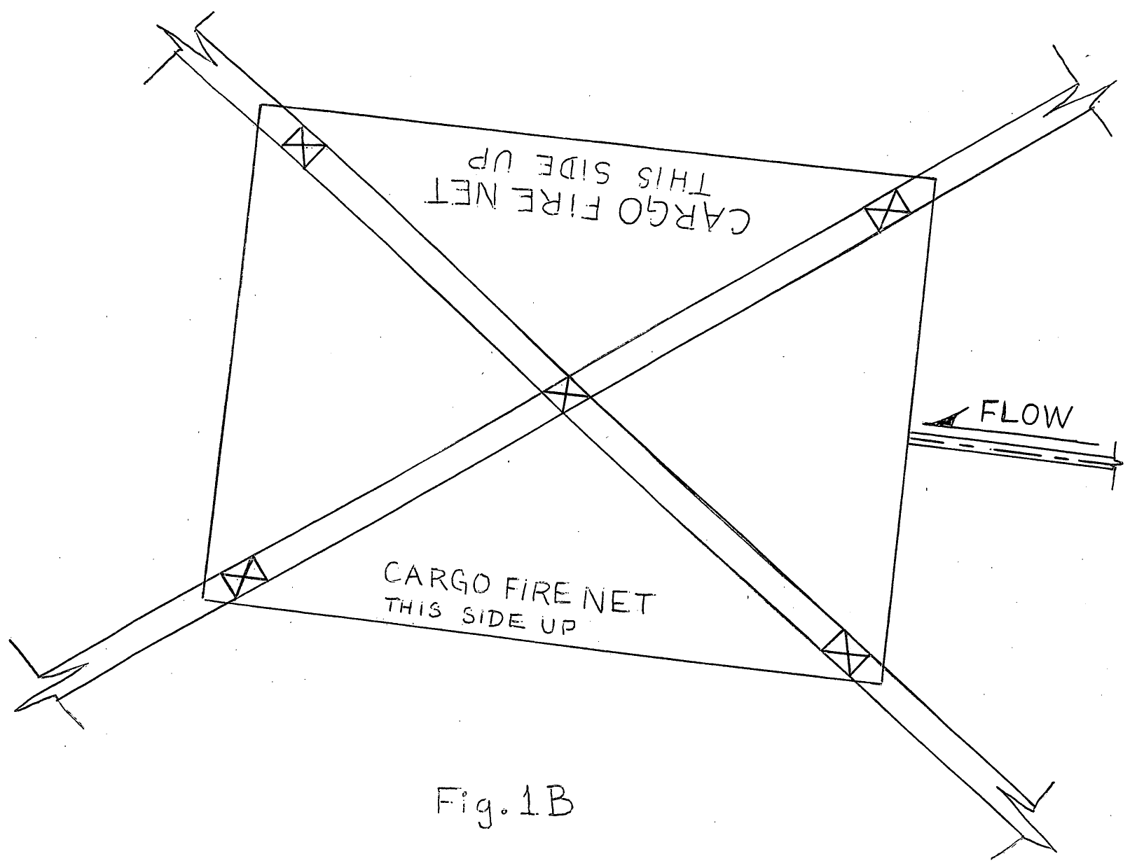

### Top View FIG. 1

Because there is nothing to really see from the top view but flame retardant fabric, the top view will actually be the bottom view, so as to show the positioning of the (8)“#6540 suppression jet heads”, and the outside dimensions of the “CARGO FIRE NET” itself. This view also allows you to see how the “long positioning straps” extend out from each corner of the “CARGO FIRE NET”.

### Suppression Line Inside View FIG. 1a

### Inside Flame Retardant Fabric

This view shows the “suppression line”, which will be made to specification of high pressure rated material, and as you can see it is layered, the “suppression lines” will be covered with flame retardant fabric, to cover like a sleeve over the “suppression lines”, the lines are to be ½″-¾″ O.D., with threaded female ends.

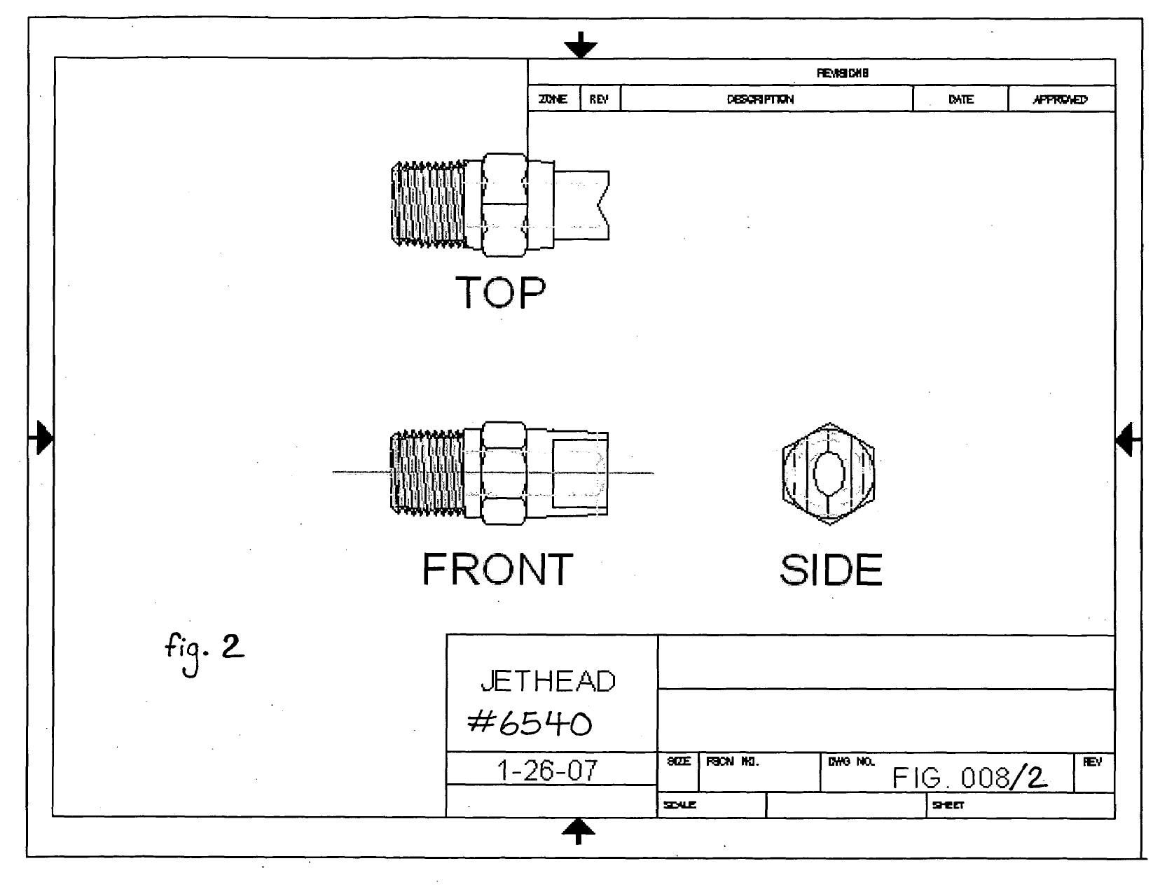

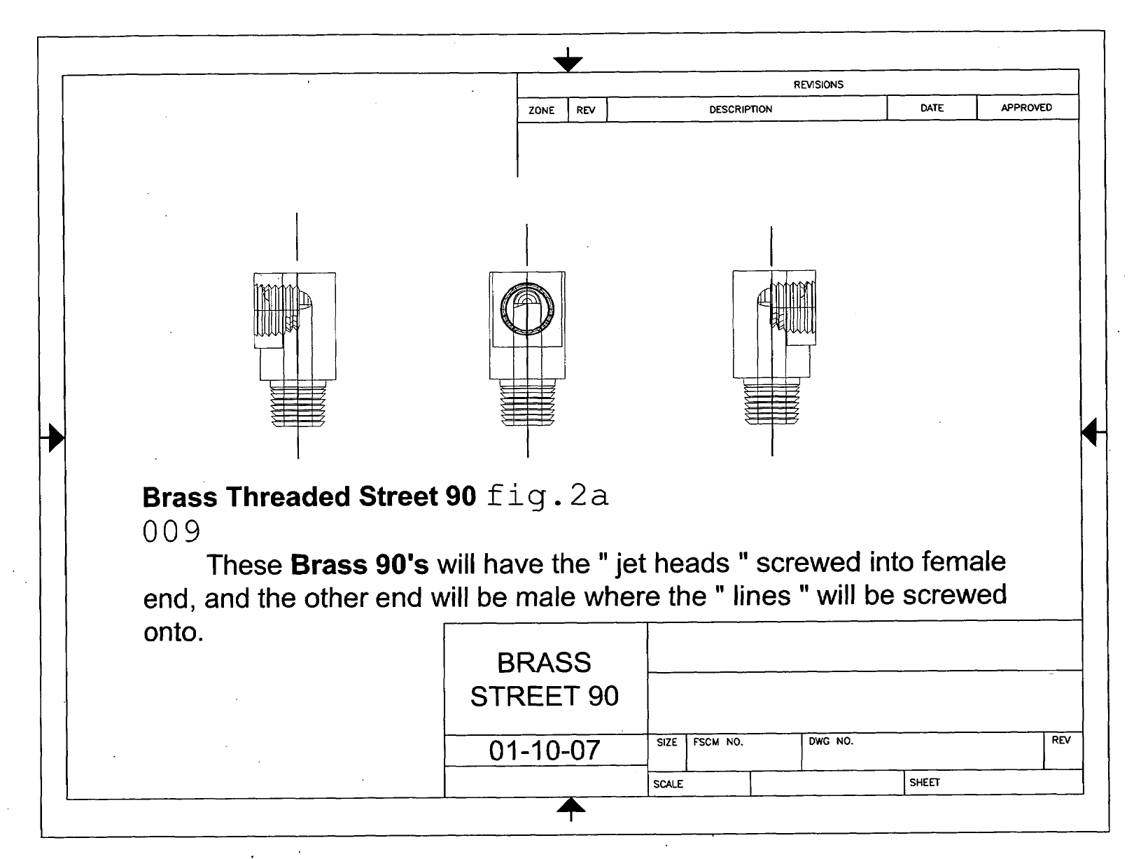

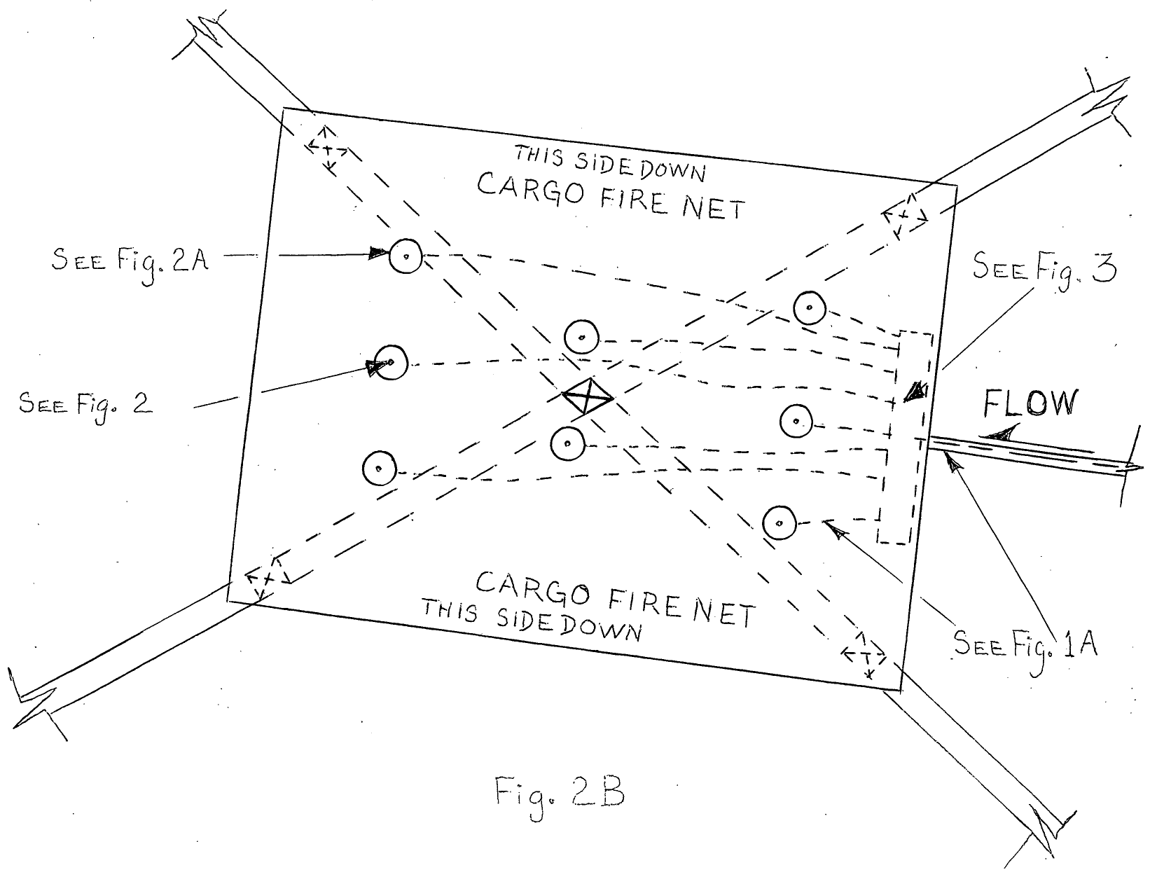

### #6540 Suppression Jet Head FIG. 2

This threaded jet head has a 1/40^{th} hole in the end of it, and produces a 65 degree fan pattern. It is to be threaded up into the female end of the “street 90”, so as to spray out the non-corrosive fire suppression agent, thus completing the operation.

### Brass Threaded Street 90 FIG. 2a

The Brass 90 will have the “#6540 suppression jet head” screwed up into the female end, and the other end being male, this will be where the female coupling of the “suppression line” will screw onto, and the coupling on the other end will be screwed onto the “manifold” itself.

### Bottom View Detailed Drawing FIG. 2b

This drawing is nothing more than a placement drawing, to show where all of the components fit in. It's meant to compliment the several views provided with leaders, and figure numbering system.

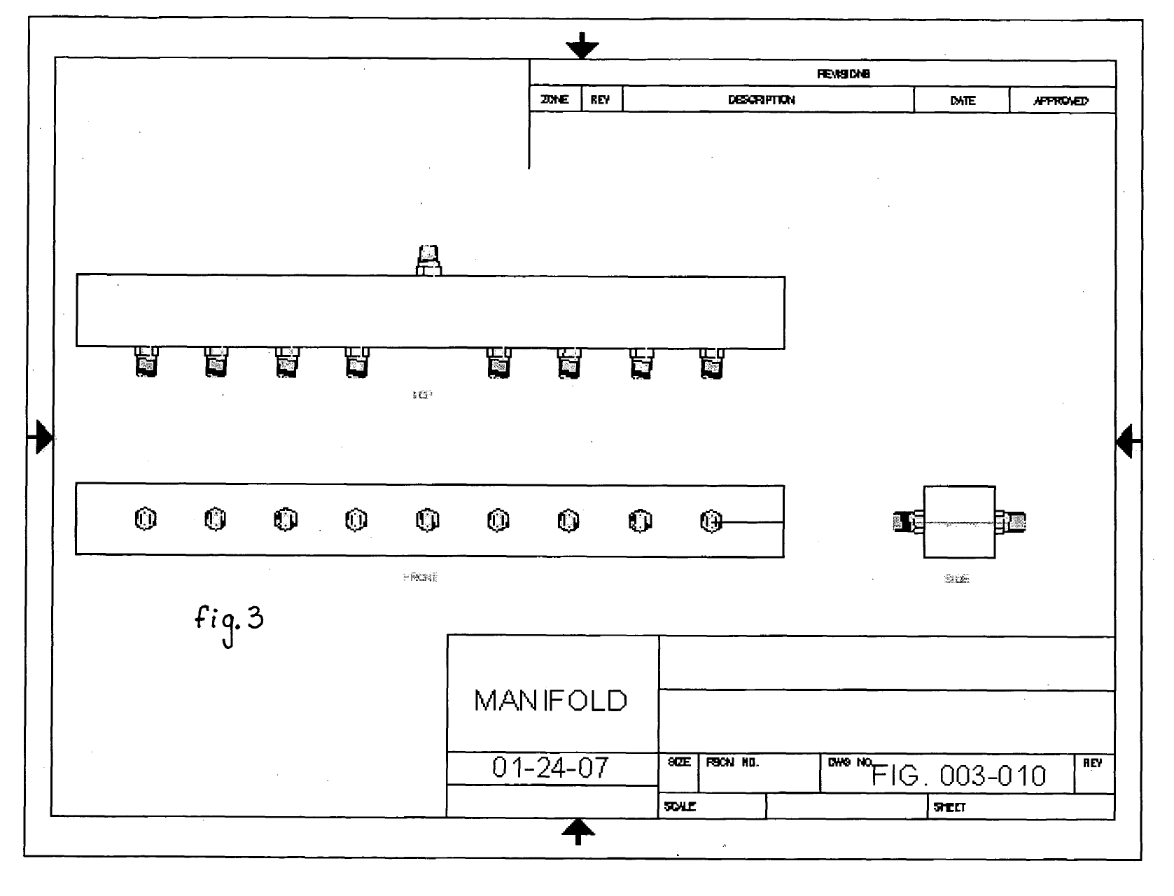

### Manifold FIG. 3

The “manifolds” purpose will be much like a splitter, i.e., on the inward flow side there will be (1) threaded port for the “feed suppression line” which leads from the pump, and the “non-corrosive fire suppression agent reservoir”. On the outward flow side there will be (8) threaded ports to accommodate the “suppression lines” that go into the “cargo fire net”, “It's a better way”.

### DETAILED DESCRIPTION OF INVENTION

I came up with the idea for the invention of the “CARGO FIRE NET” by combining 4 basic tools, i.e., net, suppression lines, #6540 suppression jet heads, and 4. heat sensors.

1.) The “cargo fire net” itself appears, much like a conventional net, it is to be made of flame retardant fabric. The fabric's construction will be so as to act much like a sleeve to cover the “suppression lines” 2.) “suppression lines” inside of, and throughout the net itself, so as to carry the non-corrosive liquid fire suppression agent to the designated “#6540 suppression jet heads” with the ability to extinguish fires through the utilization of 3.)“#6540 suppression jet heads” spaced evenly throughout the net itself. The “#6540 suppression jet heads” will be inserted by screwing them up into the ends of a brass threaded street 90's @ ½″, the other end of the 90's will be connected to the “suppression lines” themselves, thus connecting, and completing the delivery process of the non-corrosive liquid suppression agent. When activated by 4.) “heat sensors” which are somewhat exposed, so as to detect the rise in temperature, when the heat reaches an unacceptable temperature, the “#6540 suppression jet heads ” will start to spray the non-corrosive liquid fire suppression agent.

Now that being said, the “CARGO FIRE NET” can be put into position to protect cargo in two ways, 1.) Draped, making full contact with the cargo, and held in place by securing the “long positioning straps”. Although 10′-0″ long can be cut to specification. 2.) Suspended/fixed above cargo, and secured by the “long positioning straps” as well, the same holds true here per specification. Now that all systems are go, when the demand occurs for extinguishing a fire, the non-corrosive fire suppression agent must be delivered. This will be done by way of a “feed suppression line” ⅝″ O.D. leading from a 30 gal. “suppression agent holding tank”, filled with 25 parts water, and 5 parts non-corrosive liquid fire suppression agent. This single “feed suppression line” is threaded to the inward flow side of the manifold, and then out of 8 threaded ports on the outward flow side of the manifold, which is where the “suppression lines ” are connected, and from there to it's final destination, which is out of the (8) “#6540 suppression jet heads”, that are evenly spaced throughout the “cargo fire net” to extinguish the fire.

To complete the function at hand it must be powered, and to do so a “Centrifugal Pump” will be utilized as the power source, it will be spec'd. as follows; No less than 5 h.p., no less than 8 gpm, and with at least 1000 psi, “It's a better way”.

1. What I claim as my invention is what I have so named: “CARGO FIRE NET”, my invention extinguishes fires in unattended settings, such as cargo. Whether it's Airplanes, Trains, Over the Road Truckers, Ships, or even Storage Spaces with no fire protection, thus bringing them into fire code. I refer to all these settings as blind situations; any number of settings would be a bad time to have a fire, as you are at a great disadvantage as transporter, especially during transit. The transporter of the cargo doesn't exactly know when a fire starts, it can be located in an inaccessible part of the cargo, and as we all know, if you can't get to it, you can't extinguish it.
My invention of the “CARGO FIRE NET” will cover any of the aforementioned settings and more, no need for an attendant, my invention is a independent fire detection, and extinguishing system. Once the “cargo fire net” is put into position, it's ready to perform. Positioning can be done in a couple of ways; i.e., a.) Draping the “cargo fire net” directly onto the cargo itself, thus allowing up close fire protection. This method would make it truly portable, and b.) A more fixed application would be to suspend the “cargo fire net” above the cargo by using the “long positioning straps” to do so. This way cargo can be moved in, and out of holding areas without having to re-secure after each reload. The good thing about this, is the fact that a transporter can move a lot more cargo, simply because, while in the suspended, and fixed position over the cargo, and out of the way, there will be no need for securing the “cargo fire net” each time cargo is loaded, “It's a better way”.
